(19) United States
(12) Patent Application Publication
(10) Pub. No.: US 2016/0376438 A1
(43) Pub. Date: Dec. 29, 2016

(54) UREA-FREE POLYURETHANE DISPERSIONS

(71) Applicant: Covestro Deutschland AG, Leverkusen (DE)

(72) Inventor: Hans Georg GRABLOWITZ, Koln (DE)

(21) Appl. No.: 15/189,271

(22) Filed: Jun. 22, 2016

(30) Foreign Application Priority Data
Jun. 25, 2015 (EP) 15173729.3

(51) Int. Cl. C08L 75/08; C09J 175/08; C09D 175/08; C09J 175/06; C08L 75/06; C09D 175/06

(52) U.S. Cl. CPC C08L 75/08; C08L 75/06; C09D 175/06; C09D 175/08; C09J 175/06; C09J 175/08

(57) ABSTRACT

The present invention relates to an aqueous polyurethane dispersion, to a process for producing an aqueous polyurethane dispersion, to the use thereof for production of paints, coatings, sealants or adhesives, to aqueous one- or two-component coating compositions, and to paints, coatings, sealants and adhesives. The polyurethanes present are essentially free of urea groups and have an OH content of less than 0.25% by weight.

The present invention relates to an aqueous polyurethane dispersion, to a process for producing an aqueous polyurethane dispersion, to the use thereof for production of paints, coatings, adhesives or sealants, to aqueous one- or two-component coating compositions, and to paints, coatings, adhesives and sealants.

Aqueous polyurethane dispersions are nowadays frequently produced in a two-stage process, in which a polyol component is generally first reacted with a molar excess of a polyisocyanate component to give an NCO-functional prepolymer. This NCO-functional prepolymer is optionally dissolved in a solvent thereafter, or optionally even in the course of production, and chain-extended by adding a compound having at least two groups reactive toward isocyanate groups (also frequently referred to as chain extenders). This means that the molar mass of the original prepolymers is increased by reaction of their NCO groups with the NCO-reactive groups of the chain extender. Subsequently, the higher molecular weight polyurethane thus obtained is dispersed in water and the solvent is optionally distilled off. The hydrophilic groups required for the dispersion are usually introduced by introduction of polyols having ionic, potentially ionic or nonionic groups into the prepolymer or by use of chain extenders having corresponding groups.

NCO-reactive groups used in the chain extender are generally amino groups, since both primary and secondary amines are very reactive toward NCO groups. Standard chain extenders are, for example, ethylene-1,2-diamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 4,4-diaminodicyclohexylmethane, hydrazine hydrate, and/or dimethylethylenediamine, diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine, adipic dihydrazide, oxalic dihydrazide, carbohydrazide, succinic dihydrazide, or longer-chain amino-functional compounds such as polyetheramines (“Jeffamines”). The reaction of the isocyanate group with an amine always necessarily gives rise to a urea group, which is the reason why most compounds referred to as “polyurethane” are in fact “polyurethaneureas”.

Since urea groups impart a greater hardness to a polymer than urethane groups, the presence of such urea groups produced by chain extension with an amine also affects the properties of polyurethanes. However, a corresponding hardness of the polyurethaneurea is not desirable for all applications. The strong hydrogen bonds of the urea groups are likewise responsible for the fact that polyurethaneureas usually have poorer solubility than the corresponding pure polyurethanes. For this reason too, the reduction of the urea groups in the polymer chain is desirable for some applications.

An additional effect of the high reactivity of the amino group compared to the isocyanate group is that the reaction in itself proceeds very quickly, but this makes it more difficult in some cases to control the reaction. According to the process regime, the effect of this may even be that the demands on the handling of the reactants are very high in order to prevent a premature reaction of the reactants, for example in feed pipelines to the actual reactor. From the point of view of simpler processing, it would additionally be advantageous in some cases the complexity of the preparation of polyurethanes could be reduced, for example by decreasing the number of reactants involved.

In principle, there are known processes for preparation of polyurethanes having no urea groups.

For instance, EP 0 669 352 A1 describes aqueous polyester-polyurethane dispersions which can be free of urea groups. The polyester-polyurethanes of EP 0 669 352 A1 are prepared by the reaction of different polyols with a polyisocyanate component, but no chain extension takes place. Such products were developed for use as 2-component systems. Accordingly, the polyurethanes described therein have low molar masses, which are apparent from the theoretical OH content of 0.25% to 6.5% by weight. However, such molar masses are usually insufficient, particularly for 1-component compositions, to achieve the desired mechanical properties of the cured composition. Similar polyester-polyurethane dispersions are also disclosed in EP 0 578 940 A1. Here too, no process step of chain extension is conducted, and so the resulting molar masses are likewise low and are especially suitable for use in 2-component systems. Although EP 0 578 940 A1 discloses in general terms that high molar masses would be obtainable, these are not in fact achievable in practice with the starting components and ratios specified therein (especially also without chain extension), and not desirable, since this document relates to 2-component systems.

In a similar manner, in EP 2 239 286 A1, polyester-polyurethanes having a number-average molar mass of 700 to 3000 g/mol and hence an OH content of 2.5% by weight are prepared. The polyester-polyurethanes of EP 0 751 197 A1 have OH contents between 0.6% to 1.8% by weight. The polyester-polyurethanes of WO 2010/091898 A1 likewise have an OH content of 1.4% by weight.

EP 1 790 674 A1 describes hydroxy-functional polyester dispersions containing urethane groups, which likewise do not have any urea groups. The polymers are prepared either by reaction of polyols with polyisocyanates without a chain extension step or via the formation of an NCO-functional prepolymer and a subsequent chain extension with a polyester polyol. A disadvantage of the process described here is the fact that the chain extension with branched polyester polyols at a functionality of >3 runs through the equivalence point of the two co-reactants. This means that, at a particular juncture in the chain extension, the [NCO] and [OH] concentrations are equally high and hence the risk of irreversible gelation rises.

Proceeding from this prior art, the problem addressed by the present invention was that of providing an aqueous polyurethane dispersion which remedies at least one of and preferably all the abovementioned disadvantages of the prior art. More particularly, the problem addressed by the present invention was that of providing an aqueous polyurethane dispersion which has no urea groups and nevertheless has a sufficiently high molar mass. More particularly, the molar mass should be sufficient to be able to produce 1-component coating systems as well from the polyurethane dispersion, the resulting cured compositions having a sufficiently high level of mechanical properties. In addition, the risk of irreversible gelation during the production process, in particular, should be minimized. Therefore, the resulting polyurethane should preferably have good dispersibility in water to be suitable for water-based coating systems.

These problems are solved by the provision of the aqueous polyurethane dispersion of the invention, the process of the invention for production of an aqueous polyurethane dispersion, the use thereof in accordance with the invention for production of paints, coatings, adhesives and sealants, the aqueous 1- or 2-component coating compositions of the invention, and the paints, coatings, adhesives and sealants of the invention, as described in detail hereinafter.

The present invention provides an aqueous polyurethane dispersion comprising the polyurethane (P), wherein the polyurethane (P) is prepared by chain extension of at least one hydroxy-functional prepolymer (A) with at least one polyisocyanate (B), wherein the bydroxy-functional prepolymer (A) comprises at least the following formation components:
(A1) at least one polyol having a functionality >1,
(A2) optionally at least one diol other than (A1),
(A3) optionally at least one hydrophilic formation component having at least one hydrophilic group which is selected from the group consisting of an ionic group, a potentially ionic group, a nonionic group and any desired mixtures thereof, and at least one hydroxyl group, and
(A4) at least one polyisocyanate compound,
and the polyurethane (P) being essentially free of urea groups, characterized in that the polyurethane (P) has a theoretical content of hydroxyl groups of less than 0.25% by weight, based on the total weight of the polyurethane in the dried state.

In a further aspect, the present invention provides a process for producing an aqueous polyurethane dispersion, comprising the following steps in the sequence specified:

(i) preparing a hydroxy-functional prepolymer (A) from at least the following formation components:
(A1) at least one polyol having a functionality >1,
(A2) optionally at least one diol other than (A1),
(A3) optionally at least one hydrophilic formation component having at least one hydrophilic group which is selected from the group consisting of an ionic group, a potentially ionic group, a nonionic group and any desired mixtures thereof, and at least one hydroxyl group, and
(A4) at least one polyisocyanate compound,
   (ii) chain-extending the hydroxy-functional prepolymer obtained from step (i) with at least one polyisocyanate (B) to such a degree that the resulting polyurethane (P) has a theoretical content of hydroxyl groups of less than 0.25% by weight, based on the total weight of the polyurethane in the dried state, the resulting polyurethane (P) being essentially free of urea groups,
   (iii) optionally neutralizing the potentially ionic group in the optional formation component (A3) before or after step (ii), and
   (iv) dispersing the polyurethane (P) obtained from step (ii) or (iii) in water.

It has been found that, through the preparation of the OH-functional prepolymer (A) and the subsequent chain extension with the polyisocyanate (B), it is possible to obtain polyurethanes (P) which are essentially free of urea groups and simultaneously have a high molar mass, expressed by the content of hydroxyl groups of less than 0.25% by weight. It has especially been found that, by virtue of this procedure, firstly, processing is simple since one substance class of reactants fewer is required overall than in the prior art processes. This means that, in the present procedure, it is possible to use exclusively polyols and polyisocyanates and hence, more particularly, dispense with the use of amines. It has also been found that the procedure via the formation of a hydroxy-functional prepolymer (A) allows flexible and simultaneously controlled production of polyurethane dispersions overall. In principle, the prepolymer (A) can be isolated and stored without any special measures. Such a course of action would not be possible with an NCO-functional prepolymer since the comparatively reactive isocyanate groups react, for example, even with traces of water or other impurities and can also enter into other unwanted side reactions such as di- or trimerizations. However, the effect of the procedure via an OH-functional polymer is that the chain extension can be effected by means of polyisocyanate (B), entirely uncoupled from the preparation of the prepolymer (A). One way of seeing this is in terms of time. This means that the chain extension can take place at a different time from the synthesis of the prepolymer (A), the effect of which is that batch sizes of the respective reactions may be individualized from the point of view of the desired amount to be produced, the economic viability of storage, etc. At the same time, secondly, this also leads to more controlled production of polyurethane dispersions. For example, mixing of different prepolymers (A) is possible in a much simpler and more exact manner in this way, and the resulting polyurethane can be specifically tailored.

In addition, the disadvantages which inevitably arise through processes in which NCO-functional prepolymers are used are avoided. Such NCO-functional prepolymers include ever greater amounts of free isocyanate of low molecular weight. Frequently, therefore, in this procedure, a further thin-film distillation step is needed to purify the prepolymers. In addition to this aspect of dispensing with this purification with regard to energy and time, the OH-functional prepolymers of the present invention have distinctly low toxicity. In addition, the process pathway of the invention brings the advantage that the equivalence point is passed through during the preparation of the low molecular weight prepolymer, which distinctly minimizes the risk relating to possible irreversible gelation.

More particularly, it has also been found that it is possible by the procedure of the invention to use aliphatic or cycloaliphatic polyisocyanates (B) for chain extension. Since aliphatic polyisocyanates are less reactive toward hydroxyl groups than aromatic polyisocyanates, it was surprising in accordance with the invention that short reaction times in the process step of chain extension were nevertheless obtained. The person skilled in the art here would expect the reaction time in the case of aliphatic polyisocyanates to be so long that no economic utilization would seem viable (see, for example, the rate constants of the respective reactions as described inter alia in P. Król, J. Appl. Polym. Sci., 57, 6, p. 739 ff.). This prejudice was surprisingly refuted.

In one embodiment, therefore, preference is given to using an aliphatic polyisocyanate (B). In another embodiment, preference is likewise given to using an aromatic polyisocyanate (B).

According to the invention, the references to “comprising”, “containing”, etc. preferably mean “consisting essentially of” and most preferably “consisting of”.

The term “dispersion” in the context of the invention encompasses both aqueous dispersions and aqueous solutions. The distinction between a dispersion and solution depends particularly on the content of ionic groups and on the molecular weight of the polymer, and in some cases it is not possible to draw a clear boundary here, which is the reason why both configurations are encompassed in accordance with the invention. However, particular preference is given to a dispersion.

The polyurethane dispersion of the invention and the process of the invention are described hereinafter in detail and in preferred configurations. All features relate both to the dispersion and to the process, unless explicitly stated otherwise. It is therefore especially preferable that the polyurethane dispersion of the invention is obtainable or obtained by the process of the invention.

The hydroxy-functional prepolymer (A) as used in accordance with the present invention comprises at least the following formation components:
(A1) at least one polyol having a functionality >1,
(A2) optionally at least one diol other than (A1),
(A3) optionally at least one hydrophilic formation component having at least one hydrophilic group which is selected from the group consisting of an ionic group, a potentially ionic group, a nonionic group and any desired mixtures thereof, and at least one hydroxyl group, and
(A4) at least one polyisocyanate compound.

The at least one polyol component (A1) is preferably a polyol which is selected from the group consisting of a polyester polyol, polyether polyol, polyester ether polyol and a polycarbonate polyol. Preferably, the polyol component (A1) has a hydroxyl functionality of 1.2 to 4, more preferably of 1.4 to 3, most preferably of 1.5 to 2.

If component (A1) is a polyester, it is preferable that this component has theoretical molecular weights determined by calculation of 500 to 6000 g/mol, more preferably of 750 to 5000 g/mol and most preferably of 1000 to 3000/mol.

The theoretical molecular weight of the polyesters is determined by the formula: mass of the mixture [g]/(mol of COOH+mol of OH)— eq. of COOH.

It is preferable that the polyester has a hydroxyl functionality of 1.2 to 4, more preferably of 1.4 to 3, most preferably of 1.5 to 2. It is also possible to use mixtures of different polyesters and also mixtures of polyesters having different functionalities. The functionality always corresponds to the mean functionality of the mixture.

Polyesters (A1) used with preference are reaction products of
A1ᵢ) 30% to 77% by weight, preferably 40% to 60% by weight, of at least one at least difunctional carboxylic acid or anhydride thereof,
A1ᵢᵢ) 23% to 70% by weight, preferably 40%-60% by weight, of at least one diol,
   A1ᵢᵢᵢ) 0% to 10% by weight of at least one alcohol having more than 2 hydroxyl groups,
   A1ᵢᵥ) 0% to 10% by weight of other hydroxy- and/or carboxy-functional components and/or caprolactone.

Suitable polyester raw materials A1ᵢ) are, for example, phthalic anhydride, isophthalic acid, terephthalic acid, adipic acid, sebacic acid, suberic acid, succinic acid, maleic anhydride, fumaric acid, dimer fatty acids, tetrahydrophthalic anhydride, hexahydrophthalic anhydride, cyclohexanedicarboxylic acid and/or trimellitic anhydride or mixtures thereof. Preferred components A1ᵢ) are selected from the group consisting of adipic acid, phthalic anhydride, tetrahydrophthalic anhydride, isophthalic acid and glutaric acid, more preferably adipic acid, hexahydrophthalic acid and phthalic acid and the anhydrides thereof.

Suitable polyester raw materials A1ᵢᵢ) are, for example, 1,2-ethylene glycol, diethylene glycol, triethylene glycol, tetraethylene glycol, 1,2-propylene glycol, dipropylene glycol, tripropylene glycol, propane-1,3-diol, butane-1,3-diol, butane-1,4-diol, hexane-1,6-diol, neopentyl glycol, cyclohexane-1,4-dimethanol, cyclohexane-1,4-diol, butenediol, butynediol, hydrogenated bisphenols, trimethylpentanediol, octane-1,8-diol and/or tricyclodecanedimethanol and mixtures thereof. Preferred components A1.) are selected from the group consisting of butane-1,4-diol, neopentyl glycol, 1,2-propylene glycol, ethylene glycol, diethylene glycol and hexane-1,6-diol. Particularly preferred components A1ᵢᵢ) are selected from the group consisting of neopentyl glycol, butanediol, ethylene glycol, diethylene glycol and hexanediol.

Suitable optional polyester raw materials A1ᵢᵢᵢ) are, for example, trimethylolpropane, ethoxylated trimethylolpropane, propoxylated trimethylolpropane, propoxylated glycerol, ethoxylated glycerol, glycerol, pentaerythritol, castor oil and mixtures thereof. A preferred component A1ᵢᵢᵢ) is trimethylolpropane.

Suitable polyester raw materials A1ᵢᵥ) for optional use are, for example, C₈-C₂₂ fatty acids, for example 2-ethylhexanoic acid, stearic acid, hydrogenated fatty acids, benzoic acid, monofunctional alcohols such as butyl glycol, butyl diglycol, cyclohexanol, other monofunctional alcohols, for example polyethylene oxides, polypropylene oxides, polyethylene/propylene oxide blend copolymers or block copolymers and mixtures thereof.

The polyesters can be prepared by processes known per se with elimination of water at temperatures of 100 to 260° C., optionally with addition use of customary esterification catalysts, preferably by the principle of melt or azeotropic condensation. A preferred preparation process for the polyesters is melt condensation under reduced pressure or using an inert gas. In addition, suitable polyester polyols are also those obtainable by the polymerization of renewable raw materials. Reference may be made here by way of example to the use of succinic acid which is obtained by a fermentation process as described, for example, in DE 10 2008 051727 A1 or DE 10 2007 019184 A1.

If component (A1) is a polycarbonate, it is preferably a linear, hydroxy-functional polycarbonate. Suitable polycarbonates are those obtainable, for example, by reaction of carbonic acid derivatives, for example diphenyl carbonate, dimethyl carbonate or phosgene, with polyols, preferably diols. Useful diols of this kind include, for example, ethylene glycol, propane-1,2- and 1,3-diol, butane-1,3- and 1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, tetrabromobisphenol A, but also lactone-modified diols. Preferably, the diol component contains 40% to 100% by weight of hexanediol, preferably hexane-1,6-diol and/or hexanediol derivatives, preferably those having not only terminal OH groups but also ether or ester groups, for example products which have been obtained by reaction of 1 mol of hexanediol with at least 1 mol, preferably 1 to 2 mol, of caprolactone, or by etherification of hexanediol with itself to give di- or trihexylene glycol. It is also possible to use polyether polycarbonate diols. The hydroxyl polycarbonates should be essentially linear. However, they may optionally be lightly branched by the incorporation of polyfunctional components, especially low molecular weight polyols. Suitable examples for this purpose are glycerol, trimethylolpropane, hexane-1,2,6-triol, butane-1,2,4-triol, trimethylolpropane, pentaerythritol, chinit, mannitol, sorbitol, methyl glycoside or 1,3,4,6-dianhydrohexitols. The polycarbonate polyols are preferably prepared by the preparation process described in EP-A 1 404 740 (p. 6-8, Examples 1-6) and EP-A 1 477 508 (p. 5, Example 3).

Particularly preferred polycarbonate polyols are those which contain at least 25% by weight of butane-1,4-diol as formation component and have a mean hydroxyl functionality of 1.6 to 4, preferably 1.8 to 3 and more preferably 1.9 to 2.3, and a number-average molecular weight of 240 to 8000 g/mol, preferably of 500 to 3000 g/mol, more preferably of 750 to 2500 g/mol. Preferably, the diol component contains 45% to 100% by weight of butane-1,4-diol and 1% to 55% by weight of hexane-1,6-diol, more preferably 60% to 100% by weight of butane-1,4-diol and 1% to 40% by weight of hexane-1,6-diol.

If component (A1) is a polyether polyols, these are preferably polyaddition products of the styrene oxides, of ethylene oxide, propylene oxide, tetrahydrofuran, butylene oxide, epichlorohydrin, and the mixed addition and grafting products thereof, and the polyether polyols obtained by condensation of polyhydric alcohols or mixtures thereof and those obtained by alkoxylation of polyhydric alcohols, amines and amino alcohols.

Suitable hydroxy-functional polyethers preferably have OH functionalities of 1.2 to 4, more preferably of 1.4 to 3, most preferably of 1.5 to 2. Likewise preferably, they have OH numbers of 50 to 700 mg and preferably of 100 to 600 mg KOH/g of solids. Preferred molecular weights Mₙ are in the range from 106 to 4000 g/mol, more preferably from 200 to 3500 and most preferably from 500 to 3000 g/mol.

Particular preference is given to alkoxylation products of hydroxy-functional starter molecules such as ethylene glycol, propylene glycol, butanediol, hexanediol, trimethylolpropane, glycerol, pentaerythritol, sorbitol or mixtures of these and also other hydroxy-functional compounds with propylene oxide or butylene oxide. Particular preference is given to polypropylene oxide polyols and polytetramethylene oxide polyols, and mixtures thereof.

Component (A1) may also comprise any desired mixtures of the abovementioned polyols (including in a polymer chain).

The optional component (A2) is preferably at least one diol other than (A1) and having a molar mass of 62 to 450 g/mol. It is more preferably 1,2-ethylene glycol, diethylene glycol, triethylene glycol, tetraethylene glycol, 1,2-propylene glycol, dipropylene glycol, tripropylene glycol, propane-1,3-diol, butane-1,3-diol, butane-1,4-diol, hexane-1,6-diol, neopentyl glycol, cyclohexane-1,4-dimethanol, cyclohexane-1,4-diol, butenediol, butynediol, hydrogenated bisphenols, trimethylpentanediol, octane-1,8-diol and/or tricyclodecanedimethanol and mixtures thereof. Most preferably, the optional component (A2) is butane-1,4-diol, hexane-1,6-diol or neopentyl glycol.

The optional component (A3) comprises at least one hydrophilic group which is selected from the group consisting of an ionic group, a potentially ionic group, a nonionic group and any desired mixtures thereof, and at least one hydroxyl group.

Potentially ionic groups in the context of this invention are understood to mean those groups which can be converted to an ionic group by chemical reaction, especially by neutralization. Preferably, “potentially ionic” groups are understood to mean free acid groups. Likewise preferably, the salt-type groups obtained by neutralization with neutralizing agents, for example carboxylate or sulphonate groups, are “ionic” groups. Preferably, the term “nonionic” is understood to mean a compound which does not have any ionic group. Such ionic groups may be sulphonate, carboxylate, phosphate and phosphonate groups. Component (A3) serves for dispersibility of the polyurethane in water.

More preferably, component (A3) comprises at least one hydrophilic formation component having at least one hydrophilic group which is selected from the group consisting of an acid group, polyoxyalkylene ether group and any desired mixtures thereof, and at least one hydroxyl group. Suitable acid groups are, for example, carboxyl and sulpho groups.

More preferably, component (A3) is present as a formation component for the polyurethane (P).

Very particular preference is given to using, as component (A3), dimethylolpropionic acid, dimethylolbutyric acid and/or hydroxypivalic acid, very particular preference being given to using dimethylolpropionic acid. Likewise suitable acids are, for example, other 2,2-bis(hydroxymethyl)alkanecarboxylic acid, for example dimethylolacetic acid or 2,2-dimethylolpentanoic acid, dihydroxysuccinic acid, Michael addition products of acrylic acid onto amines, for example isophoronediamine or hexamethylenediamine, or mixtures of such acids and/or dimethylolpropionic acid and/or hydroxypivalic acid. It is likewise possible to use sulphonic acid diols optionally having ether groups, of the kind described in U.S. Pat. No. 4,108,814.

Likewise preferably, component (A3) comprises is a monofunctional polyethylene glycol-containing component wherein the proportion of polyethylene glycol is at least 50% by weight and which has a molar mass Mn of 1200 g/mol to 3000 g/mol. These polyethers preferably contain a proportion of 50% by weight to 100% by weight of units derived from ethylene oxide, preferably 70% by weight to 100% by weight and more preferably 80% by weight to 100% by weight, as obtainable in a manner known per se by alkoxylating the starter molecules mentioned under (A2). Alkylene oxides suitable for the alkoxylation reaction are especially ethylene oxide and propylene oxide, which can be used in the alkoxylation reaction in any sequence or else in a mixture. The molar mass Mₙ of this monofunctional polyethylene glycol-containing component (A3) is preferably 300 g/mol to 6000 g/mol, preferably 1500 g/mol to 3000 g/mol, and more preferably 2000 g/mol to 3000 g/mol.

Suitable nonionically hydrophilizing monofunctional compounds of this kind are, for example, monofunctional alkoxy polyethylene glycols, for example methoxy polyethylene glycols (MPEG Carbowax® 2000 or methoxy PEG-40, molar mass range 1800 to 2200, The Dow Chemical Company) and monofunctional polyether monoalkyl ethers, for example LB 25 formed from butanol and ethylene oxide and propylene oxide, having a mean molar mass Mₙ of 2250 g/mol, from Bayer Material Science.

Preferably, component (A3) comprises both a compound having at least one ionic group or potentially ionic group and at least one hydroxyl group, preferably the abovementioned compounds, and a compound having at least one nonionic group and at least one hydroxyl group, preferably the abovementioned compounds. It is particularly preferable that the hydrophilic formation component (A3) comprises at least the following compounds:

(A3-1) at least one ionic or potentially ionic compound having at least one acid group and at least one hydroxyl group and
(A3-2) at least one polyethylene glycol-containing compound wherein the proportion of polyethylene glycol is at least 50% by weight, having a molar mass Mn 1200 g/mol to 3000 g/mol and a hydroxyl group.

It is preferable here that component (A3-1) is used in excess relative to component (A3-2). More preferably, component (A3-1) is used in a 2- to 5-fold weight excess relative to component (A3-2).

Component (A4) is at least one polyisocyanate compound. It is preferable that this at least one polyisocyanate compound is selected from the group consisting of aromatic, araliphatic, aliphatic and cycloaliphatic polyisocyanate compounds having an NCO functionality of ≧2, which may optionally have iminooxadiazinedione, isocyanurate, uretdione, urethane, allophanate, biuret, urea, oxadiazinetrione, oxazolidinone, acylurea and/or carbodiimide structures. Such polyisocyanate compounds are known per se to those skilled in the art. They can be used individually and in any desired mixtures with one another.

Examples of suitable polyisocyanates (A4) are butylene diisocyanate, hexamethylene diisocyanate (HDI), isophorone diisocyanate (IPDI), 2,2,4- and/or 2,4,4-trimethylhexamethylene diisocyanate, pentamethylene diisocyanate (PDI), the isomeric bis(4,4′-isocyanatocyclohexyl)methanes or mixtures thereof with any isomer content, isocyanatomethyloctane 1,8-diisocyanate, cyclohexylene 1,4-diisocyanate, phenylene 1,4-diisocyanate, tolylene 2,4- and/or 2,6-diisocyanate, 1,3- and 1,4-bis(2-isocyanato-prop-2-yl)benzene (TMXDI), 1,3-bis(isocyanatomethyl)benzene (XDI), naphthylene 1,5-diisocyanate, diphenylmethane 2,4′- or 4,4′-diisocyanate, triphenyhnethane 4,4′,4″-triisocyanate or derivatives based on the aforementioned diisocyanates having uretdione, isocyanurate, urethane, allophanate, biuret, iminooxadiazinedione and/or oxadiazinetrione structure having more than 2 NCO groups. One example of an unmodified polyisocyanate having more than 2 NCO groups per molecule is 4-isocyanatomethyloctane 1,8-diisocyanate (nonane triisocyanate). Preference is given to polyisocyanates or polyisocyanate mixtures of the aforementioned type having exclusively aliphatically and/or cycloaliphatically bonded isocyanate groups. Particular preference is given to hexamethylene diisocyanate, isophorone diisocyanate, the isomeric bis(4,4′-isocyanatocyclohexyl)methane, isomers of toluene diisocyanate, diphenylmethane diisocyanate and mixtures thereof.

In a preferred embodiment, the prepolymer (A) comprises at least the following formation components:
(A1) at least one polyol having a functionality >1 selected from the group consisting of a polyester polyol, polyether polyol, polyester ether polyol and a polycarbonate polyol,
(A2) optionally at least one diol other than (A1) and having a molar mass of 62 to 450 g/mol,
(A3) optionally at least one hydrophilic formation component having at least one hydrophilic group which is selected from the group consisting of an acid group, polyoxyalkylene ether group and any desired mixtures thereof, and at least one hydroxyl group, and
(A4) at least one polyisocyanate compound which is selected from the group consisting of aromatic, araliphatic, aliphatic and cycloaliphatic polyisocyanate compounds having an NCO functionality of ≧2, which may optionally have iminooxadiazinedione, isocyanurate, uretdione, urethane, allophanate, biuret, urea, oxadiazinetrione, oxazolidinone, acylurea and/or carbodiimide structures.

Preferably, the hydroxy-functional prepolymer (A) comprises at least

50% to 87% by weight of (A1), more preferably 55% to 85% by weight of (A1),
3% to 11% by weight of (A2), more preferably 4% to 10% by weight of (A2),
0% to 24% by weight of (A3), more preferably 0% to 20% by weight of (A3), most preferably 1% to 20% by weight of (A3) and 3% to 20% by weight of (A4), more preferably 4% to 18% by weight of (A4),
where the sum total of formation components (A1) to (A4) adds up to 100% by weight (this preferably does not mean that the polyurethane cannot comprise still further additional formation components; the percentages by weight stated merely define the ratios of the percentages by weight (A1) to (A4) relative to one another).

As well as the above-described components (A1) to (A4), the polyurethane of the dispersion of the invention may include further formation components that are standard in polyurethane chemistry.

The preparation of the prepolymer (A) in process step (i) of the invention is effected in a manner known to those skilled in the art. Preferably, all the OH-functional starting components, i.e. (A1) and optionally (A2) and (A3), are initially charged and brought to the desired temperature. This temperature is preferably 40 to 150° C., even more preferably 50 to 130° C. and especially preferably 60 to 120° C. Thereafter, component (A4) is preferably added. It is preferable that, in the preparation of the hydroxy-functional prepolymer (A) (both in connection with the dispersion of the invention and the process of the invention), a molar ratio of isocyanate groups to isocyanate-reactive group of 0.25 to 0.95, even more preferably of 0.3 to 0.7 and especially preferably of 0.4 to 0.6 is present (this ratio is also referred to by the person skilled in the art as index). This means that the OH-functional components are used in excess relative to the NCO-functional components. The conversion to the prepolymer (A) is effected until essentially all the NCO groups have been consumed (i.e. no NCO groups are detectable any longer). The person skilled in the art is aware of methods of detecting NCO groups. Preferably, no NCO groups are detectable any longer by means of FT-IR analysis.

In one embodiment, it is possible to isolate and optionally store the prepolymer thus obtained. The person skilled in the art is aware of methods for this purpose. For example, the prepolymer could be dissolved in a solvent, preferably acetone. Thereafter, appropriate storage is possible.

According to the invention, prepolymer (A) is chain-extended (see also process step (ii) of the invention). According to the invention, a chain extension is understood to mean an increase in the molar mass of the prepolymer (A). A “chain extension” may also be referred to as a “reaction of the at least one hydroxy-functional prepolymer (A) with at least one polyisocyanate (B)”. This is preferably understood to mean at least a doubling of the molar mass of the prepolymer (A). The chain extension itself is effected by reaction of at least one prepolymer (A) with at least one polyisocyanate compound (B), followed by further reactions. According to the invention, the chain extension is conducted to such a degree that the resulting polyurethane (P) has a theoretical content of hydroxyl groups of less than 0.25% by weight, based on the total weight of the polyurethane in the dried state.

According to the invention, the theoretical content of hydroxyl groups is understood to mean the theoretically calculated content of OH groups remaining in the polyurethane (P) in % by weight when all the NCO groups in the polyisocyanate (B) used as chain extender have reacted with the Oil groups of the prepolymer (A). The theoretical OH content is calculated by the following formula:

Theoretical OH content=(([OH groups used in mol]−[NCO groups used in mol]*17)/mass of the prepolymer used)*100

Preferably, the resulting polyurethane (P) has a theoretical content of hydroxyl groups of less than 0.24% by weight, especially preferably of less than 0.22% by weight, further preferably of less than 0.20% by weight, further preferably of less than 0.18% by weight, more preferably of 0.00% to 0.22% by weight and most preferably of 0% by weight, based on the total weight of the polyurethane in the dried state.

According to the invention, the resulting polyurethane (P) is additionally essentially free of urea groups. A urea group in the context of the present invention is preferably understood to mean a R¹R²N—(C═O)N—R³R⁴ group where the R¹ to R⁴ radicals are each independently hydrogen or an organic radical. A urea group is also understood to mean substituted urea groups and derivatives thereof.

According to the invention, “essentially free of urea groups” preferably means that no compounds having amino groups are used at all in the chain extension. It will be appreciated that the reactants used may contain impurities which possibly also comprise amino groups in a small concentration. Such impurities can lead to the formation of urea groups, but these are still covered by the invention. Preferably, however, the reactants used to do not have any impurities having amino groups or any impurities. More preferably, the expression “essentially free of urea groups” means that the reactants used for preparation of the polyurethane (P) have 0.1% by weight or less of amino groups in relation to the sum total of the reactants used. More preferably, in this connection, “essentially free of urea groups” means that no urea groups are detectable via standard test methods, particularly preferably ¹³C NMR or IR. It is especially preferable here that the resulting polyurethane (P) has less than 0.1% by weight of urea groups (based on ═N—(C═O)—N═).

Preferably, the polyurethane (P) has the formation components of the at least one prepolymer (A) and of the at least one polyisocyanate (B), these two formation components being joined to one another exclusively via urethane groups.

The polyisocyanate (B) is preferably an aromatic polyisocyanate. In another embodiment, it is preferably an aliphatic or cycloaliphatic polyisocyanate. As already elucidated above, it has been found, surprisingly, in accordance with the invention, that it was possible to achieve chain extension within an economically viable period of time even with an aliphatic or cycloaliphatic polyisocyanate component (B).

Preferably, the at least one polyisocyanate (B) is selected from the group consisting of aromatic, araliphatic, aliphatic and cycloaliphatic polyisocyanate compounds having an NCO functionality of ≧2, which may optionally have iminooxadiazinedione, isocyanurate, uretdione, urethane, allophanate, biuret, urea, oxadiazinetrione, oxazolidinone, acylurea and/or carbodiimide structures. Such polyisocyanate compounds are known per se to those skilled in the art. They can be used individually and in any desired mixtures with one another.

Examples of suitable polyisocyanates (B) are butylene diisocyanate, hexamethylene diisocyanate (HDI), isophorone diisocyanate (IPDI), 2,2,4- and/or 2,4,4-trimethylhexamethylene diisocyanate, pentamethylene diisocyanate (PDI), the isomeric bis(4,4′-isocyanatocyclohexyl)methanes or mixtures thereof with any isomer content, isocyanatomethyloctane 1,8-diisocyanate, cyclohexylene 1,4-diisocyanate, phenylene 1,4-diisocyanate, tolylene 2,4- and/or 2,6-diisocyanate, 1,3- and 1,4-bis(2-isocyanato-prop-2-yl)benzene (TMXDI), 1,3-bis(isocyanatomethyl)benzene (XDI), naphthylene 1,5-diisocyanate, diphenylmethane 2,4′- or 4,4′-diisocyanate, triphenylmethane 4,4′,4″-triisocyanate or derivatives based on the aforementioned diisocyanates having uretdione, isocyanurate, urethane, allophanate, biuret, iminooxadiazinedione and/or oxadiazinetrione structure having more than 2 NCO groups. One example of an unmodified polyisocyanate having more than 2 NCO groups per molecule is 4-isocyanatomethyloctane 1,8-diisocyanate (nonane triisocyanate). Preferably, (B) comprises polyisocyanates or polyisocyanate mixtures of the aforementioned type having exclusively aliphatically and/or cycloaliphatically bonded isocyanate groups. Particular preference is given to hexamethylene diisocyanate, isophorone diisocyanate, the isomeric bis(4,4′-isocyanatocyclohexyl)methane, isomers of toluene diisocyanate, diphenylmethane diisocyanate and mixtures thereof.

More preferably, all compounds in the at least one polyisocyanate compound (A4) are different from all the polyisocyanates in the at least one polyisocyanate (B). This means that, when (A4) comprises several different polyisocyanate compounds, all of these differ from the compounds used as polyisocyanate (B). This is also true when (A4) comprises just one polyisocyanate compound.

The step of chain extension (see also process step (ii)) is known to those skilled in the art. More preferably, this step is effected in an inert organic solvent, preferably a keto-functional aliphatic solvent which is preferably selected from acetone and butanone, which can be added not just at the start of the preparation but optionally also in portions at a later stage. Preferably, for this purpose, the prepolymer (A) is first dissolved in this solvent. Likewise preferably, the solvent can be heated. In this case, preference is given to heating to 25 to 100° C., more preferably to 40 to 60° C. Thereafter, the at least one polyisocyanate (B) is added.

In the chain extension, it is optionally also possible to use a catalyst for the urethanization reaction. These catalysts are known per se to those skilled in the art. Preference is given to organometallic compounds, for example dibutyltin dilaurate, or tin-free metal complexes, for example Borchi® Kat 24 from OMG Borchers, Langenfeld.

The chain extension is conducted up to the desired OH content. This preferably means that the reaction is conducted until essentially all the NCO groups have been consumed (i.e. no NCO groups are detectable any longer). The person skilled in the art is aware of methods of detecting NCO groups. Preferably, no NCO groups are detectable any longer by means of FT-IR analysis. Preferably, for this purpose, a reaction time of 20 to 750 min, more preferably of 60 to 500 min, is required.

Preferably, in the chain extension, a degree of chain extension of 80% to 100%, more preferably of 90% to 100%, most preferably of 95% to 100%, is achieved. The degree of chain extension is calculated from the molar ratio of the NCO groups used in the at least one polyisocyanate (B) to the OH groups used in the prepolymer (A), multiplied by 100 (degree of chain extension=([NCO groups used in mol]/[OH groups used in mol])*100).

Should the prepolymer (A) contain potentially ionic groups in the optional formation component (A3), these should optionally be neutralized prior to the dispersion in water. This neutralization can either be effected at the prepolymer stage (A), i.e. prior to process step (ii) of the invention, or in the polyurethane (U) itself, i.e. after process step (ii) of the invention. Therefore, process step (iii) of the invention optionally comprises the neutralization of the potentially ionic group in the optional formation component (A3) before or after process step (ii).

Suitable neutralizing agents are known to those skilled in the art. They may be selected, for example, from the group consisting of triethylamine, N-methylmorpholine, dimethylisopropylamine, ethyldiisopropylamine, dimethylcyclohexylamine, triethanolamine, dimethylethanolamine, ammonia, potassium hydroxide, sodium hydroxide and any desired mixtures thereof.

This preferably achieves a degree of neutralization of at least 60%, more preferably of at least 75%, most preferably of 100%.

The polyurethane (P) thus obtained is subsequently dispersed in water, in order to obtain the aqueous polyurethane dispersion of the invention. Process step (iv) of the invention therefore provides for the dispersion of the polyurethane (P) obtained from step (ii) or (iii) in water. The dispersion of the polyurethane obtained from step (ii) is effected either when no neutralization is conducted in process step (iii) or when process step (iii) is conducted prior to process step (ii). The dispersion of the polyurethane obtained from step (iii) is effected when a neutralization is conducted in process step (iii) after process step (ii).

For performance of the dispersing step, either water can be added to the polyurethane (P) or the polyurethane (P) can be added to the water. In this case, it is possible to use the respective solvent-free polyurethane (P) or solution thereof in an inert solvent, preferably acetone. The dispersing step is generally effected within the temperature range from 20 to 100° C., preferably 40 to 100° C. The dispersibility of the polyurethane (P) can optionally be improved by additional use of external emulsifiers in the dispersing. The dispersing is optionally effected with vigorous shear.

The solvent still present in the dispersions after the dispersion step is typically then removed by distillation. Removal even during the dispersion is likewise possible. Any distillative removal of excess amounts of solvent conducted can be effected, for example, under reduced pressure at, for example, 20 to 80° C. during or after the dispersing in/with distilled water.

According to the invention, the dispersion is aqueous. This preferably means that it essentially no longer contains any organic solvent. The residual content of organic solvent is preferably below 5% by weight, more preferably below 3% by weight and most preferably below 1% by weight of the total weight of the polyurethane dispersion.

After they have been prepared, it is possible to add organic solvents to the dispersions of the invention in order to achieve particular properties, especially alcoholic solvents, for example ethanol, n-butanol, n-octanol, butyl diglycol, ethyl diglycol, methyl diglycol or methoxypropanol.

The solids content of the polyurethane dispersion of the invention is preferably between 22% and 55% by weight and more preferably between 30% and 50% by weight.

The polyurethane dispersion of the invention, in addition, preferably has a pH of 5.0 to 8.0, more preferably of 5.5 to 7.9.

The polyurethane dispersion of the invention preferably has mean particle diameters, determined, for example, by photocorrelation spectroscopy, of 50 to 500 nm, preferably of 60 to 300 nm. This is done using water as solvent and the measurement takes place at 25° C. The median particle sizes in each case are the D50 of the Z average.

More preferably, the polyurethane (P) in the dispersion has a weight-average molecular weight of 10 000 to 500 000 g/mol, more preferably of 15 000 to 400 000 g/mol and most preferably of 20 000 to 300 000 g/mol. In the context of this application, the weight-average molecular weight is preferably determined by gel permeation chromatography (GPC) in N,N-dimethylacetamide at 40° C. The procedure is in accordance with DIN 55672-2 (2008-06): “Gel permeation chromatography (GPC)—Part 2: N,N-Dimethylacetamide as elution solvent” (SECurity GPC System from PSS Polymer Service, flow rate 0.6 ml/min; columns: GRAM 3000, HEMA 300, 2×HEMA 40; UV and RI detector). Polystyrene samples of known molar mass are used for calibration. The number-average molecular weight is calculated with software support. Baseline points and evaluation limits are fixed in accordance with DIN 55672 Part 2 (2008-06).

It has been found in accordance with the invention that the polyurethane dispersions have indices, for example solids content, pH and/or mean particle diameter, comparable to standard polyurethaneurea dispersions. This means that the polyurethane dispersions of the invention can be used in just the same way as the known dispersions, but at the same time giving an improved process regime and better control over the resulting products.

In general, the aqueous polyurethane dispersion of the invention can be used for production of paints, coatings, adhesives or sealants.

In a further aspect of the present invention, an aqueous 1-component coating composition is provided, comprising

(Ia) at least one aqueous polyurethane dispersion of the invention in all preferred embodiments described, optionally in a mixture with further dispersions,
(IIa) optionally at least one blocked polyisocyanate and
(IIIa) at least one auxiliary and/or additive.

Such 1-component coating compositions are, for example, baking varnishes and coatings which are cured at temperatures of 120 to 230° C. Particularly preferred uses are baking primer-surfacer coats, one-coat paints, anti-stonechip primers and pigmented topcoats.

Any other dispersions of component (Ia) may likewise be polyurethanes or else other dispersions familiar to those skilled in the art.

Suitable blocked polyisocyanates (IIa) are, for example, reaction products of difunctional isocyanates, for example isophorone diisocyanate, hexamethylene diisocyanate, 2,4- or 2,6-diisocyanatotoluene, diphenylmethane 4,4′-diisocyanate and/or the higher molecular weight trimers thereof, biurets, urethanes, iminooxadiazinedione and/or allophanates with blocking agents, for example methanol, ethanol, butanol, hexanol, benzyl alcohol, acetoxime, butanone oxime, caprolactam, phenol, diethyl malonate, dieethyl malonate, dimethylpyrazole, triazole, dimethyltriazole, ethyl acetoacetate, diisopropylamine, dibutylamine, tert-butylbenzylamine, cyclopentanone carboxyethyl ester, dicyclohcxylamine and/or tert-butylisopropylamine.

The blocked polyisocyanates mentioned may also be converted to a water-dispersible form by incorporation of hydrophilic groups, for example carboxylate, sulphonate and/or polyethylene oxide structures, and used as such in combination with the dispersions of the invention. The blocked polyisocyanates mentioned can also be produced with additional use of hydroxy- or amino-functional components, including components of higher molecular weight, for example diols, triols, amino alcohols, polyesters, polyethers, polycarbonates and mixtures of the raw materials mentioned and/or others.

The blocked polyisocyanates (IIa) preferably have a (mean) NCO functionality of 2.0 to 5.0, preferably of 2.3 to 4.5, a content of isocyanate groups (unblocked and blocked) of 5.0% to 27.0% by weight, preferably of 14.0% to 24.0% by weight, and a content of monomeric diisocyanates of less than 1% by weight, preferably less than 0.5% by weight. The isocyanate groups of the polyisocyanates of the water-dispersible or water-soluble blocked polyisocyanates are in blocked form to an extent of at least 50%, preferably to an extent of at least 60% and more preferably to an extent of at least 70%. The water-dispersible blocked polyisocyanates IIa can be prepared by known prior art methods (for example in DE-A 2 456 469, columns 7-8, Examples 1-5, and DE-A 2 853 937 p. 21-26, Examples 1-9).

Suitable auxiliaries or additives (IIIa) for formulation of 1-component coating compositions are known to those skilled in the art. These are, for example, surface-active substances, emulsifiers, stabilizers, anti-settling agents, UV stabilizers, catalysts for the crosslinking reaction, defoamers, antioxidants, anti-skinning agents, levelling agents, thickeners and/or bactericides.

In a further aspect of the present invention, an aqueous 2-component coating composition is provided, comprising

(Ib) at least one aqueous polyurethane dispersion of the invention in all preferred embodiments described, optionally in a mixture with further dispersions,
(IIb) at least one polyisocyanate (C) and
(IIIb) at least one auxiliary and/or additive.

Any other dispersions of component (Ib) may likewise be polyurethanes or else other dispersions familiar to those skilled in the art.

Suitable auxiliaries or additives (IIIb) for formulation of 2-component coating compositions are known to those skilled in the art. These are, for example, surface-active substances, emulsifiers, stabilizers, anti-settling agents, UV stabilizers, catalysts for the crosslinking reaction, defoamers, antioxidants, anti-skinning agents, levelling agents, thickeners and/or bactericides.

Likewise provided in one aspect of the present invention is a paint, coating, adhesive or sealant which is obtained by curing the aqueous polyurethane dispersion of the invention in all the preferred embodiments described on at least part of a substrate. According to the invention, the curing can preferably be effected by drying and optionally additional chemical crosslinking.

The invention is to be illustrated in detail by the examples which follow.

### EXAMPLES

### Raw Materials:

Desmophen 1652 (DE 1652): polyester polyol formed from adipic acid, butane-1,4-diol, ethylene glycol, diethylene glycol, having a molar mass of 2000 g/mol (BAYER AG, Leverkusen)
Polyether sulphonate (PETS): Polypropylene oxide diol having a sodium sulphonate group and a molar mass of 435 g/mol (BAYER AG, Leverkusen)
PTHF2K: Polytetramethylene oxide diol having a molar mass of 2000 g/mol (ALDRICH, Germany).
C2200: Polyhexamethylene carbonate diol having a molar mass of 2000 g/mol (BAYER AG, Leverkusen)
Butane-1,4-diol (BDO): (ALDRICH, DE)
LB 25: Monohydroxy-functional polyether formed from ethylene oxide and propylene oxide, having a proportion by weight of 84% ethylene oxide and a molar mass of 2250 g/mol (BAYER AG, Leverkusen)
Desmodur I (IPDI): isophorone diisocyanate (BAYER AG, Leverkusen)
Desmodur H (HDI): hexamethylene diisocyanate (BAYER AG, Leverkusen)
Desmodur T 80 (T80): toluene diisocyanate (80% toluene 2,4-diisocyanate and 20% toluene 2,6-diisocyanate, BAYER AG, Leverkusen)
Desmodur T 100 (T100): toluene diisocyanate (100% toluene 2,4-diisocyanate, BAYER AG Leverkusen)
Desmodur 2460 M (MDI): diphenylmethane diisocyanate (isomer mixture of diphenylmethane 2,4′- and 4,4′-diisocyanate, BAYER AG Leverkusen)
DMPS: dimethylolpropanoic acid (DMPA, ALDRICH, Germany)
TEA: triethylamine (ALDRICH, Germany)
Borchikat 24: tin-free urethanization catalyst (OMG Borchers, Langenfeld, Germany)

### Methods:

The viscosity was determined using a Haake viscometer at room temperature (23° C.) with a shear rate of 45 s-1.

The solids contents (SCs) were determined to DIN EN ISO 3251.

The median particle sizes (MPS) were determined by means of photocorrelation spectroscopy (Malvern Instruments, model: Zetasizer 1000).

### Preparation of the Dismernons:

### General Method for Production the Dispersions of the Invention

The appropriate amount of the OH-functional raw materials are initially charged in a reaction vessel and heated up to a temperature of 70° C. On attainment of the target temperature, the specified amount of polyisocyanate 1 is added, and the mixture is heated to 100° C. and stirred until no free isocyanate is apparent any longer by means of IR measurement. The prepolymer is cooled down to 50° C. and then dissolved in acetone (50% solution). Polyisocyanate 2 and 200 ppm of the urethanization catalyst Borchikat 24 are added. The chain extension is effected under reflux within the reaction time specified (t CE) and the conversion is checked at regular intervals by means of IR until the reaction mixture no longer has any free isocyanate. Thereafter, the mixture is cooled down to 50° C. and demineralized water is added to the dispersion (the amount being calculated such that the acetone-free PUD has a theoretical solids content of 35.0% by weight). Thereafter, the acetone is distilled off at 45° C. under reduced pressure (125 mbar) to obtain a high molecular weight polyurethane dispersion free of urea groups and solvent.

| | | | | | OH | | | |
|---|---|---|---|---|---|---|---|---|
| | OH-functional | | | | (PUD)/% | NCO-functional | | |
| Ex. | Polyol/g | BDO/g | Hydrophilic/g | LB25/g | by wt. | Isocyanate 1/g | Isocyanate 2/g | t CE/min |
| 1 | DE 1652 | 25.9 | PETS | 11.3 | 0 | IPDI | T80 | 190 |
| | 158.5 | | 27.2 | | | 47.2 | 37.4 | |
| 2 | PTHF2K | 15.3 | PETS | 9.0 | 0 | IPDI | T80 | 195 |
| | 239.6 | | 21.8 | | | 37.7 | 29.9 | |
| 3 | C2200 | 15.3 | PETS | 9.0 | 0 | IPDI | T80 | 205 |
| | 239.6 | | 21.8 | | | 37.7 | 29.9 | |
| 4 | DE 1652 | 15.3 | PETS | 9.0 | 0 | IPDI | MDI | 460 |
| | 254.0 | | 21.8 | | | 37.7 | 47.1 | |
| 5 | DE 1652 | 15.3 | PETS | / | 0 | IPDI | T80 | 190 |
| | 254.4 | | 21.8 | | | 37.7 | 29.9 | |
| 6 | DE 1652 | 33.8 | / | / | 0 | IPDI | T80 | 90 |
| | 292.0 | | | | | 16.7 | 12.4 | |
| 7 | DE 1652 | / | / | 33.8 | 0 | IPDI | HDI | 120 |
| | 292.6 | | | | | 16.7 | 10.7 | |
| 8 | DE 1652 | / | / | 33.8 | 0 | IPDI | IPDI | 120 |
| | 292.6 | | | | | 16.7 | 14.1 | |
| 9 | DE 1652 | 15.3 | PETS | 4.5 | 0 | IPDI | HDI | 195 |
| | 254.2 | | 21.8 | | | 37.7 | 28.5 | |
| 10 | DE 1652 | 15.3 | PETS | 4.5 | 0 | IPDI | T80 | 180 |
| | 254.2 | | 21.8 | | | 42.2 | 26.4 | |
| 11 | DE 1652 | 15.3 | PETS | 4.5 | 0 | IPDI | T80 | 390 |
| | 254.2 | | 21.8 | | | 47.2 | 22.4 | |
| 12 | DE 1652 | 15.3 | PETS | 4.5 | 0 | IPDI | T80 | 420 |
| | 254.2 | | 21.8 | | | 53.9 | 17.1 | |
| 13 | DE 1652 | 15.3 | PETS | 9.0 | 0 | IPDI | T100 | 360 |
| | 254.0 | | 21.8 | | | 37.7 | 29.9 | |
| 14 | DE 1652 | 15.3 | DMPS* | 4.5 | 0 | IPDI | T80 | 150 |
| | 177.9 | | 11.5 | | | 37.7 | 29.9 | |
| 15 | DE 1652 | 25.9 | PETS | 11.3 | 0.22 | IPDI | T80 | 255 |
| | 158.5 | | 27.2 | | | 47.2 | 34.4 | |

*Prepolymer is dissolved in acetone and then neutralized with triethylamine; neutralization level corresponds to 100%

| Ex. | SC/% by wt. | pH | Viscosity/mPas | MPS/nm |
|---|---|---|---|---|
| 1 | 36.3 | 7.2 | 55 | 100 |
| 2 | 36.4 | 7.2 | 80 | 195 |
| 3 | 35.4 | 6.2 | 30 | 145 |
| 4 | 33.8 | 6.3 | 30 | 255 |
| 5 | 35.4 | 7.5 | 20 | 370 |
| 6 | 35.3 | 5.5 | 20 | 225 |
| 7 | 37.1 | 5.8 | 15 | 130 |
| 8 | 35.4 | 6.4 | 20 | 140 |
| 9 | 33.9 | 6.9 | 10 | 295 |
| 10 | 34.6 | 7.0 | 20 | 105 |
| 11 | 35.0 | 6.1 | 40 | 95 |
| 12 | 37.2 | 6.2 | 45 | 110 |
| 13 | 34.4 | 5.8 | 25 | 150 |
| 14 | 34.9 | 7.9 | 1400 | 120 |
| 15 | 34.4 | 6.0 | 135 | 55 |

It can be seen that the polyurethane dispersions of the invention have indices comparable to standard polyurethaneurea dispersions. It is possible here to produce anionic or nonionic particles, or else combined anionic-nonionic particles. The anionic groups are in the form of sulphonate or carboxylate groups.

1.-15. (canceled)

16. An aqueous polyurethane dispersion comprising a polyurethane (P), wherein the polyurethane (P) is obtained by chain extension of at least one hydroxy-functional prepolymer (A) with at least one polyisocyanate (B), the hydroxy-functional prepolymer (A) comprising at least the following formation components:
(A1) at least one polyol having a functionality >1,
(A2) optionally at least one diol other than (A1),
(A3) optionally at least one hydrophilic formation component having at least one hydrophilic group selected from the group consisting of an ionic group, a potentially ionic group, a nonionic group and mixtures thereof, and at least one hydroxyl group, and
(A4) at least one polyisocyanate compound,
wherein the polyurethane (P) is essentially free of urea groups, and wherein the polyurethane (P) has a theoretical content of hydroxyl groups of less than 0.25% by weight, based on the total weight of the polyurethane in the dried state.

17. A process for preparing an aqueous polyurethane dispersion, comprising the following steps in the sequence specified:
(i) preparing a hydroxy-functional prepolymer (A) from at least the following formation components:
(A1) at least one polyol having a functionality >1,
(A2) optionally at least one diol other than (A1),
(A3) optionally at least one hydrophilic formation component having at least one hydrophilic group which is selected from the group consisting of an ionic group, a potentially ionic group, a nonionic group and any desired mixtures thereof, and at least one hydroxyl group, and
(A4) at least one polyisocyanate compound,
(ii) chain-extending the hydroxy-functional prepolymer obtained from step (i) with at least one polyisocyanate (B) to such a degree that the resulting polyurethane (P) has a theoretical content of hydroxyl groups of less than 0.25% by weight, based on the total weight of the polyurethane in the dried state, the resulting polyurethane (P) being essentially free of urea groups,
(iii) optionally neutralizing the potentially ionic group in the optional formation component (A3) before or after step (ii), and
(iv) dispersing the polyurethane (P) obtained from step (ii) or (iii) in water.

18. The aqueous polyurethane dispersion according to claim 16, wherein the polyurethane (P) has a theoretical content of hydroxyl groups of not more than 0.24% by weight, based on the total weight of the polyurethane in the dried state.

19. The aqueous polyurethane dispersion according to claim 16, wherein the polyisocyanate (B) is an aromatic polyisocyanate.

20. The aqueous polyurethane dispersion according to claim 16, wherein all the compounds in the at least one polyisocyanate compound (A4) are different from all the polyisocyanates in the at least one polyisocyanate (B).

21. The aqueous polyurethane dispersion according to claim 16, wherein there is a molar ratio of isocyanate groups to isocyanate-reactive group in the preparation of the hydroxy-functional prepolymer (A) of 0.25 to 0.95.

22. The aqueous polyurethane dispersion according to claim 16, wherein the chain extension achieves a degree of chain extension of 80% to 100%.

23. The aqueous polyurethane dispersion according to claim 16, wherein the hydroxy-functional prepolymer (A) comprises at least the following formation components:
(A1) at least one polyol having a functionality >1 selected from the group consisting of a polyester polyol, polyether polyol, polyester ether polyol and polycarbonate polyol,
(A2) optionally at least one diol other than (A1) and having a molar mass of 62 to 450 g/mol,
(A3) optionally at least one hydrophilic formation component having at least one hydrophilic group which is selected from the group consisting of an acid group, polyoxyalkylene ether group and any desired mixtures thereof, and at least one hydroxyl group, and
(A4) at least one polyisocyanate compound which is selected from the group consisting of aromatic, araliphatic, aliphatic and cycloaliphatic polyisocyanate compounds having an NCO functionality of ≧2, which may optionally have iminooxadiazinedione, isocyanurate, uretdione, urethane, allophanate, biuret, urea, oxadiazinetrione, oxazolidinone, acylurea and/or carbodiimide structures.

24. The aqueous polyurethane dispersion according to claim 16, wherein the hydrophilic formation component (A3) comprises at least the following compounds:
(A3-1) at least one ionic or potentially ionic compound having at least one acid group and at least one hydroxyl group and
(A3-2) at least one polyethylene glycol-containing compound wherein the proportion of polyethylene glycol is at least 50% by weight, having a molar mass Mn of 1200 g/mol to 3000 g/mol and a hydroxyl group.

25. The aqueous polyurethane dispersion according to claim 16, wherein the hydroxy-functional prepolymer (A) comprises at least
50% to 87% by weight of (A1),
3% to 11% by weight of (A2),
0% to 24% by weight of (A3) and
3% to 20% by weight of (A4),
where the sum total of formation components (A1) to (A4) adds up to 100% by weight.

26. The aqueous polyurethane dispersion according to claim 16, wherein the aqueous polyurethane dispersion has a solids content of 20% to 55% by weight.

27. An aqueous one-component coating composition comprising
(Ia) at least one aqueous polyurethane dispersion according to claim 16, optionally in a mixture with further dispersions,
(IIa) optionally at least one blocked polyisocyanate and
(IIIa) at least one auxiliary and/or additive.

28. An aqueous two-component coating composition comprising
(Ib) at least one aqueous polyurethane dispersion according to claim 16, optionally in a mixture with further dispersions,
(IIb) at least one polyisocyanate (C) and
(IIIb) at least one auxiliary and/or additive.

29. A method comprising producing a paint, coating, adhesive or sealant comprising the aqueous polyurethane dispersion according to claim 16.

30. A paint, coating, adhesive or sealant obtained by curing the aqueous polyurethane dispersion according to claim 16 on at least part of a substrate.
